(19) United States
(12) Patent Application Publication
(10) Pub. No.: US 2004/0029518 A1
(43) Pub. Date: Feb. 12, 2004

(54) Motivational coin storage device

(76) Inventors: Petra Helene Tanidis, Victoria (AU); Arthur Tanidis, Victoria (AU)

Correspondence Address: MICHAEL BEST & FRIEDRICH, LLP, 100 E WISCONSIN AVENUE, MILWAUKEE, WI, 53202, US

(21) Appl. No.: 10/344,220

(22) PCT Filed: Aug. 13, 2001
(86) PCT No.: PCT/AU01/00993

(30) Foreign Application Priority Data
Aug. 11, 2000 (AU) PQ9356

(51) Int. Cl. G07D 9/06

(52) U.S. Cl. 453/61

(57) ABSTRACT

Coin storage device (2) for storing a plurality of different sized coins of different values or denominations in a range of individual compartments (12) in which the coins of one denomination are all stored in the same compartment. The device includes a base portion (4) and a top portion (20) having a fixed structural member (10) extending therebetween to maintain the top (10) and base (4) portion in spaced apart parallel relationship to each other. The sizes of the individual compartments correspond to the respective sizes of the coins being stored therein and the lengths of the interior of the compartments (12) corresponds to a predetermined value or amount of money of the coin being stored therein such that when each compartment (12) is full of coins the predetermined amount is stored in the device (2) and the device is provided with an indication of when the predetermined amount has been attained so that actual counting of the coins is not required.

The present invention relates generally to a storage device and particularly to a device for storing coins, tokens, gambling chips, or similar disc-like items. More particularly the present invention relates to a money saving device having a number of separate compartments in which coins of the one denomination or value can be stored collectively in respective compartments in an ordered, array or similar configuration. Even more particularly the present invention relates to a money saving device having a specific target or goal saving amount such that when all of the separate compartments of the device are full of coins or the like the specific target amount is achieved without the person saving the coins having to actually count the coins to determine their value or amount. The present invention finds particular application as a motivational money box providing a visual indication of the amount of money saved thereby providing information as to the further amount to be saved to meet the specific target saving amount and providing incentive for further saving to reach the target amount, as well as obviating the need to actually count the money saved in order to determine whether the target amount has been attained.

Although the present invention will be described with reference to one embodiment of the present invention it is to be noted that the scope of the invention is not limited to the described embodiment, but rather the scope of the invention is more extensive so as to include other forms and arrangement of the device and the use of the various forms of the device in other applications.

Conventional money boxes come in a variety of shapes, sizes and forms. However, whilst there is a variety in the type of money box almost all are provided with a slot or similar for introducing coins internally into the money box and an opaque receptacle portion for storing the money when in the box obscured from view so that there is no way of determining how much money has been saved to date. Coins are usually inserted into the slot for retention in the money box but the amount of coins residing in the money box cannot be observed and the target amount or amount saved is not identifiable by observation. Furthermore, when the coins are inserted into the money box they are added to the mix of coins already in the money box so that all of the coins irrespective of their denomination are mixed together and there is no sorting or differentiation of the coins according to their size or value within the receptacle portion of the money box ie. the coins are all randomly mixed in together in the money box.

When a saver believes that sufficient coins have been added to the money box to have reached a particular predetermined saving target the money box is opened and the collection of coins emptied whereupon the saver sorts the coins into a single value or denomination group, arranging the coins into groups, such as for example, into piles representing a dollar or multiple dollars or other monetary unit and then counting each of the groups or piles by adding the identified piles together to determine the exact sum of the total of the coins stored in the money box. Such an exercise is laborious and time consuming since the coins require sorting and stacking before the total sum can be calculated. If the saver, having sorted and stacked the coins, has not attained the saving target the coins are reintroduced into the money box and the same exercise repeated at a later date when additional coins have been inserted into the money box in the expectation that the specific saving target has been attained. For some savers, the repeated sorting and stacking of coins which do not meet the specific saving target could be a deterrent to further saving to reach the predetermined saving amount or to saving altogether. In either case the repeated sorting, stacking and counting is time consuming and tedious.

Additionally, as the coins are added to the money box and disappear from view the saver is not provided with an indication, particularly a visual indication, of how much is being accumulated in the money box so that the novelty of saving may soon be forgotten when there is no information provided about whether or not the specific saving target has been obtained. Further, there is no indication, particularly a visual indication, of how the saving is progressing and how much has been saved to date or how much more is required to go to reach the saving target. Thus, there are a number of significant disadvantages of existing money boxes.

Accordingly, there is a need to provide a coin storage device in the form of a money box which overcomes the need to repeatedly sort, stack and count coins to determine the amount saved, which additionally provides a visual indication of how far towards reaching a specific target saving the saver has obtained thus far, which provides an incentive to keep saving to reach the target amount and which obviates the need to count the coins to determine the amount saved when the device is full.

Therefore, it is an aim of the present invention to provide a motivational coin saving device or storage device which overcomes the need to separately stack the coins into single denominations and also provides a visual indication of the amount of money being saved at any one time toward the specific target saving amount and which when full has the target saving amount contained therein without having to count the actual amount saved to determine its value.

According to the present invention, there is provided a coin storage device for storing a plurality of different sized coins of different values or denominations in a multiplicity of individual compartments in which the coins of one denomination are all stored in the same compartment including a base portion forming the base of the device, said base portion being interconnected to a top portion forming the top of the device, said top portion having a receiving means associated with each individual compartment, said multiplicity of compartments extending from the base portion to the top portion, and in which one or more compartments are provided with a spacer portion located at or towards one end of the compartment, wherein the size of the compartment corresponds to the size of the coin being stored therein, and the length of the interior of the compartment for storing the coins corresponds to a predetermined value or amount of money of the coin being stored therein such that when each compartment is full of coins the predetermined amount is stored in the device, said device having an indication of when the predetermined amount has been attained.

According to another aspect of the present invention there is provided a method of storing coins in a coin storage device having a plurality or multiplicity of individual compartments for receiving coins of the one amount or denomination in which the coins of one denomination are all stored in the same compartment, one or more of the compartments being provided with a spacer portion, said method including the steps of inserting coins into respective compartments according to the value of the coin, collecting the coins in the respective compartments in stacked relationship with each other such that when each compartment is full a predetermined amount of money is stored within the device said device having an indication of when the predetermined amount has been attained.

Typically, the device is arranged to store a plurality of different sized coins of different values or denominations, however this does not preclude the arrangement of 2 or more compartments storing one size of coin of a single value or denomination.

Typically, the device is arranged to store a predetermined amount of money. Typically, the predetermined amount of money is a multiple of a dollar or similar base monetary value. Even more particularly, the amount of money varies from about $20 to $1000 depending on the nature of the currency. Even more typically, the total amount of money stored in the storage device is $20, $30, $100, $300, $500 or the like.

Typically, there are a plurality of individual compartments. Typically, there are two, three, four, five, six, seven or more separate compartments. More typically, each compartment stores coins of the one value, such as for example, one compartment is for storing 5¢ coins, another for 10¢ coins, a still further for 20¢ coins and so on for each coin of an individual currency.

Typically, the compartments are arranged in a regularly spaced apart array. Typically, the array is a circular array or similar. Even more typically, there is a central compartment aligned along the central axis of the device. Even more typically, the centrally located storage compartment is for storing notes or other items, particularly non-coin items.

Typically, the compartments are clear, transparent, translucent or the like so that the number of coins stored in the compartments is readily observable.

Typically, the compartments are tubular, more typically the compartments are cylindrical or round tubes. Typically, the internal diameter of the cylindrical tube corresponds to the external diameter of the denomination of coin to be stored in stacked relationship within the particular tube. More typically, the tubes are made from plastics material preferably clear plastics material such as methyl methacrylate, perspex or the like.

Typically, the central tube is a structural tube for interconnecting the base and top of the device together. More typically, the central tube is solid or substantially solid. Even more typically, the central tube is fixedly attached to the base unit, the unit or to both the base and top units. Even more typically, the central tube is a fixed solid structural column which is optionally provided with a cap. Typically, the central column is removable or disconnected from the top, base or from both.

The multiplicity of tubes all have different diameters depending upon the value and size of the coin being stored within the particular tube. More typically, the tubes are provided with means for determining how many coins are being stored. Even more typically, the tubes are graduated. Even more typically, the graduations which are imprinted onto the side walls of the tube provide a visual indication of the amount of coins in the tube having the graduations. Typically, the graduations are located internally within the side walls of the compartments.

Typically, the base is provided with a receiving means for receiving the tubes. More typically, there is a receiving means for each tube. More typically, the receiving means is a hole, aperture, bore, cavity or the like. Even more typically, the receiving means is circular.

Each tube is of a length to store a predetermined number of coins and/or a predetermined amount of money. Each tube is provided with a spacer portion, pedestal portion, base portion, stepped portion or similar located at or towards one end. Typically, the spacer, pedestal or base is located towards the lower end in use of the tube where the tube connects to the base of the storage device. The height of the step, spacer, pedestal or base is in accordance with the size of the tube. Typically, the height of the step, spacer, pedestal or base is arranged so that when the predetermined number of coins or amount of money is stored within the tube the coins in stacked relationship reach to the top of the tube. Typically, when all of the tubes are full the coins within each individual tube all reach to a common height, such that the top-most coin of each tube is at the same height as every other top-most coin. There is a single height for all of the coins in stacked relationship in the multiplicity of compartments irrespective of the size of the tubes and the number and amount of coins. The spacers located at the bottom of the tubes are in stepped relationship to each other.

Typically, each tube is removable from the device. Typically, the tube is removable through the top portion, more typically through the receiving means in the form of an aperture, bore or similar provided in the top portion.

Typically, each tube is provided with a cap. More typically, the cap is removable. Even more typically, the cap is provided with a slot. Typically the slot is in accordance with the size of the coin being stored in the particular tube allowing the coin to be passed through the slot.

Typically the caps are provided with a means that preferably prevent further coins being inserted into a tube once the target number of coins in said tube is reached.

Typically, the tubes or compartments assist in maintaining the structural rigidity of the device as well as being for storing the saved coins.

Typically, the tubes are removable from the device for transporting the money in predetermined amounts.

Typically, the receiving means of the top of the device is in the form of an aperture. More typically, the aperture is counter sunk so as to be able to receive the removable cap of each cylindrical tube. Typically, the top surface of each removable cap is embossed with indicia indicating the denomination of the coin to be stored in the tube.

Typically, a simple equation using the relationship between the number of coins in a tube and the denomination of the coins in said tube can be used to determine the total amount of money stored in the tube, such as for example 40×10¢=$4. Typically this equation is indicted on the tube.

Typically, each device is stackable with respect to other similar devices to increase the amount of money able to be stored in the devices when in stacked or nested relationship to each other.

Typically, the device is provided with a microchip or other sensor to detect a predetermined amount of money within the storage device so as to provide a visual or aural indication that an intermediate target amount has been achieved thereby providing further encouragement or incentive for the saver to save more so as to reach the specific target saving amount.

Typically, the storage device is provided with a light including an integral light or an internal light for providing enhanced visual appeal of the storage device. More typically, the light is a fibre optic light.

Typically, the storage device is rotatable, pivotal or otherwise movable about the central axis on its base.

Typically, the device can be a one piece device or a multi-piece device.

Typically, the base portion and lid portion are maintained in spaced apart relationship to each other by a central column which is fixed to the base and top portion to maintain the device. In this embodiment the tubes for receiving the various coins of denominations are removable and located at spaced apart locations around the central column.

Typically, the device may be coloured, tinted, decorated or otherwise visually enhanced to improve the visual appeal of the device. Typically, the device is provided with a drawer, preferably a removable or detachable drawer to facilitate easier handling and removal of saved coins.

The present invention will now be described by way of example with reference to the accompanying drawings in which:

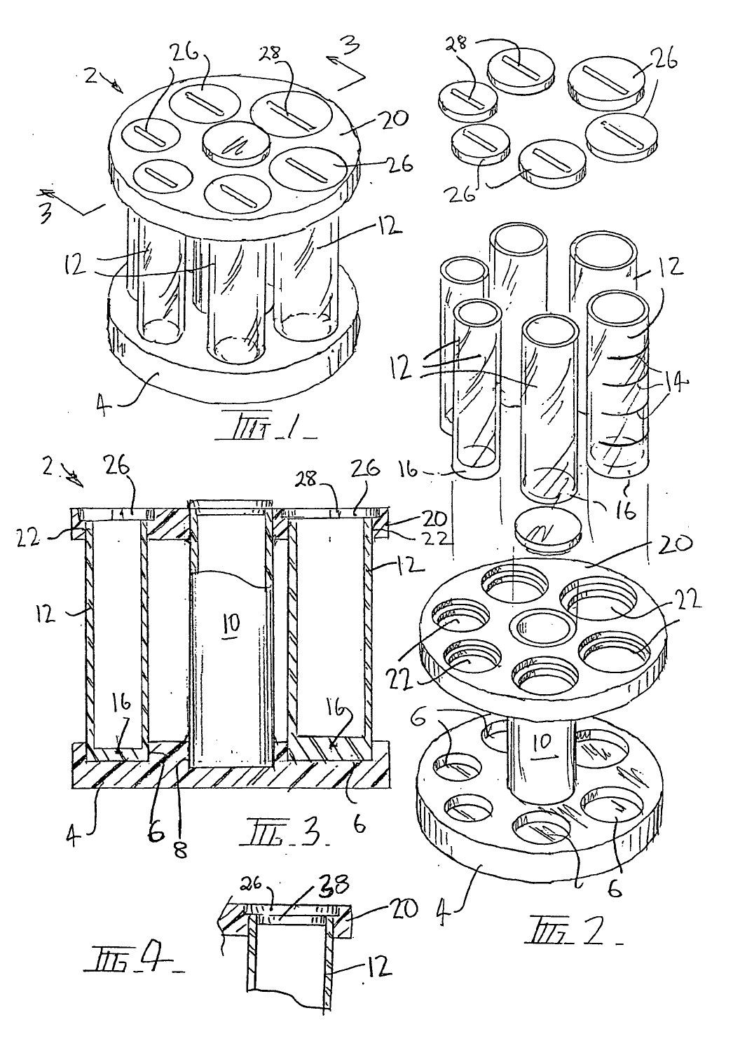

FIG. 1 is a top isometric view of one form of the assembled storage device of the present invention when empty of coins,

FIG. 2 is an exploded view of the form of the storage device of FIG. 1 showing the various component parts,

FIG. 3 is a horizontal cross-section view taken along the line 3 to 3 of FIG. 1,

FIG. 4 is a close up view of one form of the receiving means in the top of the storage device,

In FIG. 1 there is shown a top perspective view of one form of the storage device, generally denoted as 2, of the present invention for storing coins. The device is shown as being empty of coins. Device 2 includes a substantially circular base 4 for supporting the storage device 2 on a suitable substrate. Base 4 is preferably made from a clear plastics material. Base 4 can be of any suitable shape, form, thickness or size. In one form base 4 is substantially solid whereas in another form base 4 is relatively smaller diameter corresponds to the outer diameter of the respective tube to be received in this part of the bore and the relatively larger diameter corresponds to the external diameter of removable cap 26 provided at the top of each tube. Removable cap 26 is provided with a diagonal slot 28 of a length corresponding to the diameter of the coin being stored in -the respective tube so that the coin of a specific size, denomination or value can be inserted through the slot for storage in the tube.

Central column 10 extends from base 4 to top 20 for maintaining the base and top in spaced apart relationship and to provide structure and rigidity for the device.

Each tube 12 is provided with a spacer portion 16 or similar located at or towards the lower end in use of the device. The height of the spacer portion 16 is in accordance with the thickness, value or denomination of the coin being stored in the respective tube. The spacer 16 is of a thickness such that when the tube is full of coins a certain predetermined amount of money or number of coins is stored within the tube. The length of the solid spacers or pedestals are provided so that when all of the tubes are full to capacity the target saving amount is stored within the storage device. Further, it is to be noted that the spacers of each tube are in stepped relationship to each other so that when each tube 12 is full of the desired coins the top most coin of each tube is at the same height as the top most coin of all other tubes. The stepped relationship of spacers 16 is shown in FIG. 3.

With particular reference to FIG. 4, cap 26 is shown provided with flanged portion 38 for being received in the top of tube 12 when cap 26 is in place sealing the top of the tube. It is to be noted that cap 26 can take any suitable form or arrangement.

In use of the storage device, of the present invention coins of a certain value or denomination are inserted through the slot of the caps and dropped into the individual tubes of the corresponding denomination for storage therein. As the tubes are made from transparent or at least translucent plastic material or similar the amount of coins being stored within each tube is readily observable. To assist in assessing the number of coins in each tube the graduations 14 in the form of horizontal markings indicate the number of coins being stored at any one time in each individual tube 12 and thus provide an indication of the amount saved at that time and an incentive to continue saving. Coins are added to the storage device 2 until all of the tubes are full. When all of the available space within the tubes 12 is filled the saver knows that the saving target amount has been reached without having to undergo the time-consuming task of sorting the coins, stacking the sorted coins into piles of a single value and counting all of the coins to calculate the total sum of the coins saved.

In one embodiment the device 2 is a stand alone device having a set saving target. In other embodiments the device is provided with rims or flanges along the base 4 or top 20 or both allowing two or more devices 2 to be stacked in nested relationship one upon the other in order to increase the target saving amount.

In one form of the storage device of the present invention the target amount is set for $100. With six transparent or translucent coin tubes 12 in which to place 5, 10, 20, 50 cent coins and $1 or $2 coins into the respective tubes.

In another form of the device of the present invention the target amount is set for $20 with 5 and 10 cent transparent or translucent coin tubes being available within which to place 5 cent and 10 cent coins until the target saving amount has been reached. Other forms of the device can have other target values depending upon the particular currency being saved.

It is to be noted that the number and size of tubes can be changed in accordance with the particular currency in use within any desired country.

Advantages of the present invention include the following.

The device of the present invention also serves as a useful place in which to put all unwanted coins that are lying around people's homes or the like. Children in particular count large amounts of coins by sorting, stacking, piling and counting their savings from their money boxes, piggy banks or similar. The device of the present invention takes the guesswork out of saving. It also encourages people to see a useful purpose for small petty change, and to teach the value of money, such as for example, by helping to see the value of 5¢/10¢ turn into $100's watching their money grow thus providing an incentive for saving. People quickly learn not to be frivolous with small change when they want to fill up the storage device. It motivates people to become avid savers when they have a set target amount that they can focus on attaining at a glance.

In another form, the shape of the device may vary. The coin tubes could be made deeper, and add up to a different saving target. More coin tubes could also be added to increase saving target amount.

In another form, the coin currencies may change and therefore the tube sizes would vary according to the coin dimensions.

The money saving device of the present invention may be manufactured from any suitable material, such as plastic or perspex. A detachable drawer may be added to allow for easier handling and removal of saved coins.

The described arrangement has been advanced by explanation and many modifications may be made without departing from the spirit and scope of the invention which includes every novel feature and novel combination of features herein disclosed.

Those skilled in the art will appreciate that the invention described herein is susceptible to variations and modifications other than those specifically described. It is understood that the invention includes all such variations and modifications which fall within the spirit and scope.

1. A coin storage device for storing a plurality of different sized coins of different values or denominations in a multiplicity of individual compartments in which the coins of one denomination are all stored in the same compartment characterised in that the storage device includes a base portion forming the base of the device, said base portion being interconnected to a top portion forming the top of the device, said top portion having a receiving means associated with each individual compartment, said multiplicity of compartments extending from the base portion to the top portion, and in which one or more compartments are provided with a spacer portion located at or towards one end of the compartment, wherein the size of the compartment corresponds to the size of the coin being stored therein, and the length of the interior of the compartment for storing the coins corresponds to a predetermined value or amount of money of the coin being stored therein such that when each compartment is full of coins the predetermined amount is stored in the device, said device having an indication of when the predetermined amount has been attained.

2. A device according to any preceding claim characterised in that the spacer portion is located at or towards the lower end in use of the container, where the container connects to the base of the storage device.

3. A device according to any preceding claim characterised in that the length of the interior of the compartment for storing the coins is substantially the length between the top of the spacer portion and the opposite end of the compartment.

4. A device according to any preceding claim characterised in that the length of the interior of the compartment for storing the coins each tube is of a length to store a predetermined number of coins or a predetermined amount of money.

5. A device according to any preceding claim characterised in that when all of the containers are full, the coins within each individual container all reach to a common height, such that the top most coin of each container is at the same height as every other top most coin in the other containers.

6. A device according any preceding claim characterised in that there are two, three, four, five, six, seven or more separate compartments.

7. A device according to any of the preceding claims wherein two or more compartments store the same sized coins of the same values or denomination.

8. A device according to any of the preceding claims wherein 2 or more compartments store the same sized coins of the same values or denomination.

9. A device according to any preceding claim characterised in that the compartments are arranged in a regularly spaced apart array, pattern, arrangement, configuration or similar.

10. A device according to any preceding claim characterised in that the array or similar is a substantially circular array or similar.

11. A device according to any preceding claim characterised in that the compartments are arranged about a central member aligned along the central axis of the device and are arranged around the central member in a more or less regularly spaced apart array.

12. A device according to any preceding claim characterised in that the central member is a structural support member extending between the base and the top.

13. A device according to any preceding claim characterised in that the compartments are tubular.

14. A device according to any preceding claim characterised in that the compartments are cylindrical or round tubes.

15. A device according to any preceding claim characterised in that the internal diameter of the cylindrical tube corresponds to the external diameter of the denomination of coin to be stored in stacked relationship in the tube so that a coin inserted into the tube correctly orients itself in the tube in stacked relationship with other coins.

16. A device according to any preceding claim characterised in that the central tube is solid or substantially solid or is hollow or substantially hollow.

17. A device according to any preceding claim characterised in that the multiplicity or plurality of tubes all have different diameters depending upon the value, size or denomination of the coin being stored therein.

18. A device according to any preceding claim characterised in that the tubes are graduated or provided with graduations.

19. A device according to any preceding claim characterised in that each tube is removable from the device.

20. A device according to any preceding claim characterised in that the tube is removable through the top portion, preferably through the receiving means located in the top portion.

21. A device according to any preceding claim characterised in that the receiving means is in the form of an aperture, hole, bore, counter bore or similar provided in the top portion.

22. A device according to any preceding claim characterised in that each tube is provided with a cap, preferably a removable cap and more preferably a slotted removable cap.

23. A device according to any preceding claim characterised in that the tubes are transparent, translucent, clear or similar.

24. A device according to any preceding claim characterised in that there are two or more similar devices stackable with respect to each other.

25. A method of storing coins in a coin storage device having a plurality or multiplicity of individual compartments for receiving coins of the one amount or denomination in which the coins of one denomination are all stored in the same compartment, one or more of the compartments being provided with a spacer portion, said method including the steps of inserting coins into respective compartments according to the value of the coin, collecting the coins in the respective compartments in stacked relationship with each other such that when each compartment is full a predetermined amount of money is stored within the device characterised in that the device is provided with an indication of when the predetermined amount has been attained.

26. A coin storage device substantially as herein before described with reference to the accompanying drawings.

27. A method of storing coins in a coin storage device substantially as herein before described with reference to the accompanying drawings.
